(19) United States
(12) Patent Application Publication
(10) Pub. No.: US 2017/0015240 A1
(43) Pub. Date: Jan. 19, 2017

(54) Kendyll's Watching

(71) Applicant: Dorothea Jacobs, Houston, TX (US)

(72) Inventor: Dorothea Jacobs, Houston, TX (US)

(21) Appl. No.: 14/802,280

(22) Filed: Jul. 17, 2015

(51) Int. Cl. B60Q 9/00; B60N 2/28; B60N 2/00; G08B 21/02; G08B 21/24

(52) U.S. Cl. CPC B60Q 9/00; G08B 21/0277; G08B 21/0288; G08B 21/24; B60N 2/002; B60N 2/28; G08B 21/023

(57) ABSTRACT

The unique features of this invention will provide the following benefits to infants and their parents and caregivers. Children will no longer be forgotten or left behind to suffer needless deaths from excessive heat or cold when forgotten in unattended vehicles. Drivers and caretakers will be reminded immediately to check the back seat before walking away from their vehicles. The lives of children may be saved, and parents will have peace of mind, knowing they will never forget about their children in the backseats of their vehicles. What is new in this invention is the awareness of our children not being left behind in vehicles and to be protected by this stand-alone device that will alert the parent or caregiver.

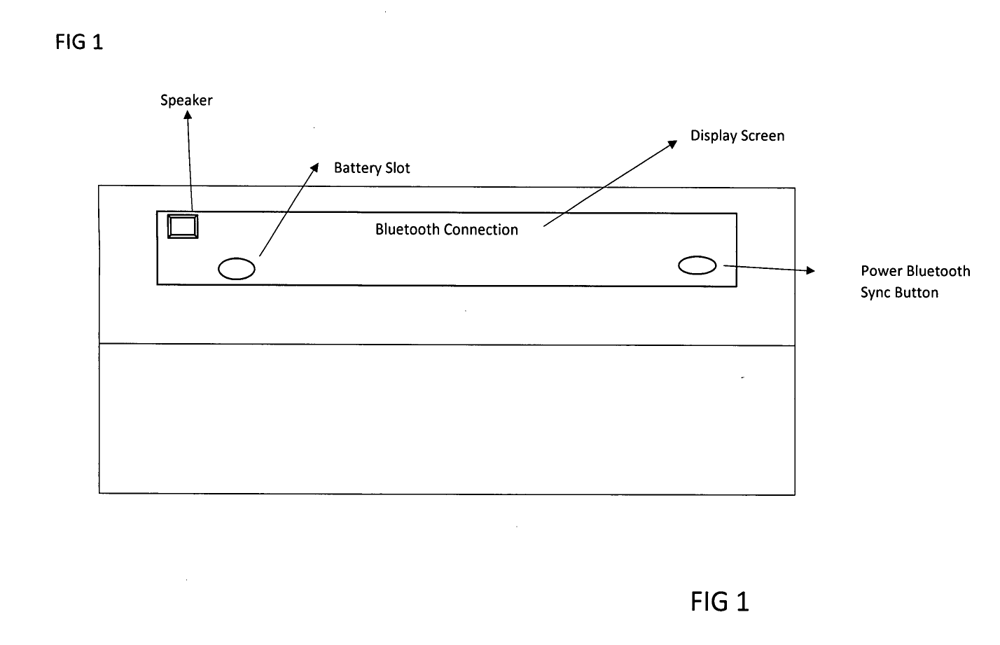

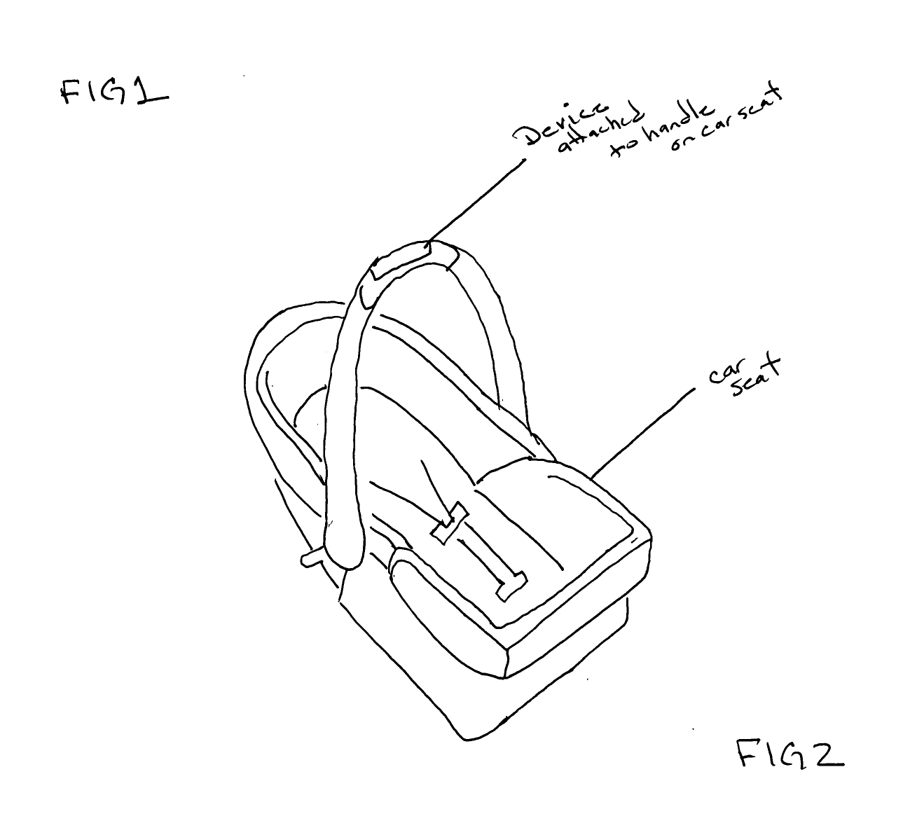

### CROSS-REFERENCE RELATED APPLICATIONS

Previous application filed for a Provisional Patent for Kendyll's Watching. The application was filed on Jul. 24, 2014. The application number is 62028687, docket number 510492744 this application expired Jul. 24, 2015 this is the reason for filing the Utility Patent.

### STATEMENT REGARDING FEDERALLY SPONSORED RESEARCH/DEVELOPMENT

NA

### REFERENCE TO SEQUENCE LISTING, A TABLE, COMPUTER PROGRAM LISTING, COMPACT LIST

NA

### BACKGROUND OF INVENTION

This invention is in the field of safety. To safeguard children from being left behind in vehicles before the parent or caregiver attempts to leave the vehicle. The device is designed to protect children from the fatalities that has been in our papers and on the news.

The problem is that infants are being left in hot vehicles after the parent/caregiver has left the vehicles. Based on the statistics from the Department for Health and Climate Science during the period from 1998 to present, there has been 623 infant fatalities due to infants being left in hot vehicles. The report of US heatstroke fatalities of children left in vehicles in 2014 have been 14 and in 2013 the fatalities were 44 and based on these statistics an infant heatstroke fatality will occur about 38 per year. This result with percentages of 51%, a child was forgotten by a parent/caregiver and 18% where a child was intentionally left in the vehicle by an adult/parent. (gg.weather.com)

### BRIEF SUMMARY OF INVENTION

Our nation has experienced a tremendous tragedy in reference to our children, infants in particular. We need to safeguard our children from the tragedy of being left behind in vehicles with the result of infant fatalities. We have designed a device that will alert the parent/caregiver that the infant is still in the vehicle as he or she goes to exit the vehicle. This device can be mounted on or built into the infant car seat which will then be activated by light (solar device) to trigger the alarm when the vehicle door is ajar via the dome light in the vehicle. The infant seat belt will connect to the vehicle computer system when the seat belt is fasten to trigger when the vehicle door is ajar to alert the parent/caregiver the infant is still in his or her seat belt. The device can be registered through the internet to activate. This will prevent the numbers children lost to fatalities due to being left in cars. By implementing this device will demonstrate the concern we have for our children and families and that we have an interest in solving the problem of infant fatalities.

Based on the statistics from the Department for Health and Climate Science during the period from 1998 to present, there has been 623 infant fatalities due to infants being left in hot vehicles. The report of US heatstroke fatalities of children left in vehicles in 2014 have been 14 and in 2013 the fatalities were 44 and based on these statistics an infant heatstroke fatality will occur about 38 per year. This result with percentages of 51%, a child was forgotten by a parent/caregiver and 18% where a child was intentionally left in the vehicle by an adult/parent. (gg.weather.com)

The device itself is the solution. As the device will be used along with the infant car seat and utilize the infant seat belt to save the lives of our infants left in vehicles to alert the parent that his or her child is still in the vehicle. Prevention is the key here in preventing any further fatalities. The device will either connect with the vehicle computer system for activation or charge from the light as a solar device as the device will be built in the car seat or attach separately to alert the parent the infant is in the vehicle if the vehicle door is ajar.

As currently designed in the technical drawings and 3-D models, the invention has unique features not presently available in the marketplace. Although the system has not yet been engineered and is still in the 3-D developmental stages, an explanation of possible operation is as follows:

This new alarm system, Kendyll's Watching, is designed to remind parents and caregivers about a child or infant sitting in the car seat. The unit, with a speaker and display screen, fits around the carrying handle on a baby's car seat. It is synched to the computer system in the vehicle, via Bluetooth connectivity, and is activated when the vehicle is stopped and a door is opened. It can be solar-powered, battery-powered or wired to the interior lights inside the vehicle.

As soon as the vehicle is no longer in motion and a door is opened, the alarm will be sounded. It may be a computerized voice or a jarring sound, similar to the sound heard when a seat belt is not fastened. A driver or someone riding in the vehicle will hear the alarm before exiting, and be reminded about the child in the car seat. Parents and caregivers can read the information on the display screen when placing the child in the car seat to be reassured that the system is working properly.

This art work shows the components for the device:
(1) The display screen—shows the Bluetooth is connected or disconnected.
(2) Speaker—allow the alert sound to be heard.
(3) Battery slot—insert battery for power.
(4) Power button for the Bluetooth—to turn the device on or off.

This art work shows the components for the device after attachment:
(1) Demonstrates how the display screen will be seen after device is attached to car seat.
(2) Demonstrates how the device wraps around the handle of the car seat.
(3) Demonstrates where the power button will be located once device it is attached.
(4) Demonstrates the car seat that the device will be attached to.
(5) Demonstrates where the battery slot will be located after attachment of the device.
(6) Demonstrates where the speaker may be seen after the device is attached.

This art work shows the components of the device at a different angle:
(1) Demonstrates the display screen for the Bluetooth connection.
(2) Demonstrates the power button.
(3) Demonstrates the battery slot.
(4) Demonstrates the speaker location.

### DETAILED DESCRIPTION OF INVENTION

The concept envisioned is an alarm system, so parents and care providers transporting children, will be reminded about a child who may be sleeping in the back seat. A sensor is attached to the baby's safety seat and activated, via the vehicle's computer system, anytime the vehicle is not moving, a door is opened, and an infant or child is strapped into his or her seat. A further, more detailed explanation of the functionality of this invention will be elaborated upon in the following segment.

As currently designed in the technical drawings and 3-D models, the invention has unique features not presently available in the marketplace. Although the system has not yet been engineered and is still in the 3-D developmental stages, an explanation of possible operation is as follows:

This new alarm system, Kendyll's Watching, is designed to remind parents and caregivers about a child or infant sitting in the car seat. The unit, with a speaker and display screen, fits around the carrying handle on a baby's car seat. It is synched to the computer system in the vehicle, via Bluetooth connectivity, and is activated when the vehicle is stopped and a door is opened. It can be solar-powered, battery-powered or wired to the interior lights inside the vehicle.

As soon as the vehicle is no longer in motion and a door is opened, the alarm will be sounded. It may be a computerized voice or a jarring sound, similar to the sound heard when a seat belt is not fastened. A driver or someone riding in the vehicle will hear the alarm before exiting, and be reminded about the child in the car seat. Parents and caregivers can read the information on the display screen when placing the child in the car seat to be reassured that the system is working properly.

This is beneficial for making any necessary modifications and revisions for improvements; thus promoting a more satisfactory and overall accommodating product.

1. The claim that I define as the protection of my invention is that no one else has a device that will attach to a baby car seat and alert the parent or caregiver that an infant in still in the car before he or she exist the vehicle. This device will attach to any car seat and connect to the vehicle computer system to alert the parent or caregiver when the vehicle car door is ajar. The claim and protection that I define is that no one may duplicate this device and claim it as their invention as this would not be true. This is the only stand-alone device that will attach to a car seat and provide the protection of the child being left in a vehicle.
